(19) United States
(12) Patent Application Publication
(10) Pub. No.: US 2011/0238737 A1
(43) Pub. Date: Sep. 29, 2011

(54) DECENTRALIZED CLOUD STORAGE

(75) Inventors: Nitin Agrawal, Princeton, NJ (US); Cristian Ungureanu, Princeton, NJ (US)

(73) Assignee: NEC Laboratories America, Inc., Princeton, NJ (US)

(21) Appl. No.: 12/850,228

(22) Filed: Aug. 4, 2010

Related U.S. Application Data
(60) Provisional application No. 61/317,848, filed on Mar. 26, 2010.

(51) Int. Cl. G06F 15/16

(52) U.S. Cl. 709/203; 709/226

(57) ABSTRACT

A decentralized cloud storage system is provided which comprises at least one client having local resources. The local resources include a first portion which is accessible to the at least one client and a second portion designated to be accessible to and managed by a cloud storage service having a computer readable storage medium. A server logic module is configured to allocate responsibility for performing a set of functions between back-end resources of the cloud storage service and the local resources designated by the at least one client. The system also includes a controller configured to manage the resources designated by the at least one client to implement the functions which have been allocated to the at least one client.

### RELATED APPLICATION INFORMATION

This application claims priority to provisional application Ser. No. 61/317,848 filed on Mar. 26, 2010, incorporated herein by reference.

### BACKGROUND

1. Technical Field

The present invention relates to providing cloud storage, and more particularly, to a decentralized cloud storage architecture which utilizes a portion of resources delegated by clients in conjunction with backend resources of a cloud storage service.

2. Description of the Related Art

Cloud storage provides a solution for storing and managing large volumes of data. However, conventional cloud storage systems only present a viable option for a limited set of applications, such as backup and archiving data. The limited use of conventional cloud storage systems is primarily a result of latency issues (e.g., the latencies associated with I/O operations) experienced by the end user application. In addition, many users have concerns regarding the privacy or confidentiality associated with transmitting information to a remote storage site.

Regarding the latency issue, even if the backend of the cloud storage provider delivers high performance and low latency, the latency experienced by the application may still be quite significant. This is due, at least in part, to the limitations and constraints imposed on wide area networks (WANs).

Further complicating the problem is the fact that some users simply do not want to trust a third-party vendor to keep their data confidential. Unless cloud-storage services provide simple mechanisms to ensure privacy of stored data, a number of users will simply not use cloud storage.

### SUMMARY

In accordance with the present principles, a decentralized cloud storage system is provided which comprises at least one client having local resources. The local resources include a first portion which is accessible to the at least one client and a second portion designated to be accessible to and managed by a cloud storage service. A server logic module is configured to allocate responsibility for performing a set of functions between back-end resources of the cloud storage service and the local resources designated by the at least one client. The system also includes a controller configured to manage the resources designated by the at least one client to implement the functions which have been allocated to the at least one client.

In accordance with the present principles, a method for providing a decentralized cloud storage system is also provided. The method includes the step of designating local resources of at least one client to be managed by a cloud storage service which comprises a computer readable storage medium. A set of functions are determined which are to be provided to an application on the at least one client in conjunction with a cloud storage service. Responsibility for performing the set of functions is allocated between back-end resources of the cloud storage service and the local resources designated by the at least one client. The local resources designated by the at least one client are managed to implement the functions which have been allocated to the at least one client.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a decentralized cloud storage architecture in accordance with the present principles.

FIG. 2 is a block/flow diagram illustrating a decentralized cloud server connected to a plurality of client machines in accordance with the present principles.

FIG. 3 is a block/flow diagram illustrating a method for providing a decentralized cloud storage architecture in accordance with the present principles.

### DETAILED DESCRIPTION OF PREFERRED EMBODIMENTS

In accordance with the present principles, a decentralized cloud storage architecture is provided which utilizes the backend resources of a cloud storage provider and a fraction of the resources at the clients. In contrast to convention systems, the cloud storage architecture in accordance with the present principles provides for a high level of cooperation between the client and the server. The server has access to some or all of the client resources, thus allowing the server to make decisions that affect the usage of those resources and further permitting the server to implement operations on those resources. By delegating a fraction of local storage or other resources at a client to be managed by the cloud storage provider, functions which are traditionally performed solely at the cloud storage provider's end of the system can be divided between the service provider and the client. As a result, the performance experienced by the client applications can be significantly improved and the demands placed on the cloud servers can be relaxed.

In one particular embodiment, the combined resources of the client and the backend cloud service are utilized in a manner which serves to reduce or mitigate the latencies associated with providing a cloud service over a wide area network (WAN). Since input/output (I/O) latencies represent the primary obstacle which prevent cloud storage from being used in conjunction with many applications, eliminating or reducing these latencies permits cloud storage services to become a viable option for a wider range of applications.

Traditional methods of improving the performance of a cloud service involve making server-side innovations (e.g., adding additional resources on the service provider's end). However, such innovations can become quite expensive. Moreover, the potential improvements that can be achieved by making such innovations on the server-side tend to be reduced because of constraints imposed by networks (e.g., WANs). Thus, by utilizing the resources of both the clients on the front-end of the system and the servers on the backend of the system, a greater improvement in performance can be achieved.

Upon reading this disclosure, one of ordinary skill in the art will recognize that the decentralized cloud storage architecture described herein provides for a number of advantages over conventional cloud storage systems. In accordance with the present principles, a decentralized cloud storage system permits a cloud storage service to be provided at a reduced cost and permits additional applications to be used in conjunction with cloud-storage services (i.e., applications which did not traditionally present viable options for use with cloud storage service). Moreover, the principles herein permit for latency to be reduced in a manner which is much more effective than conventional methods, and further permits for a reduction in the overall system complexity.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

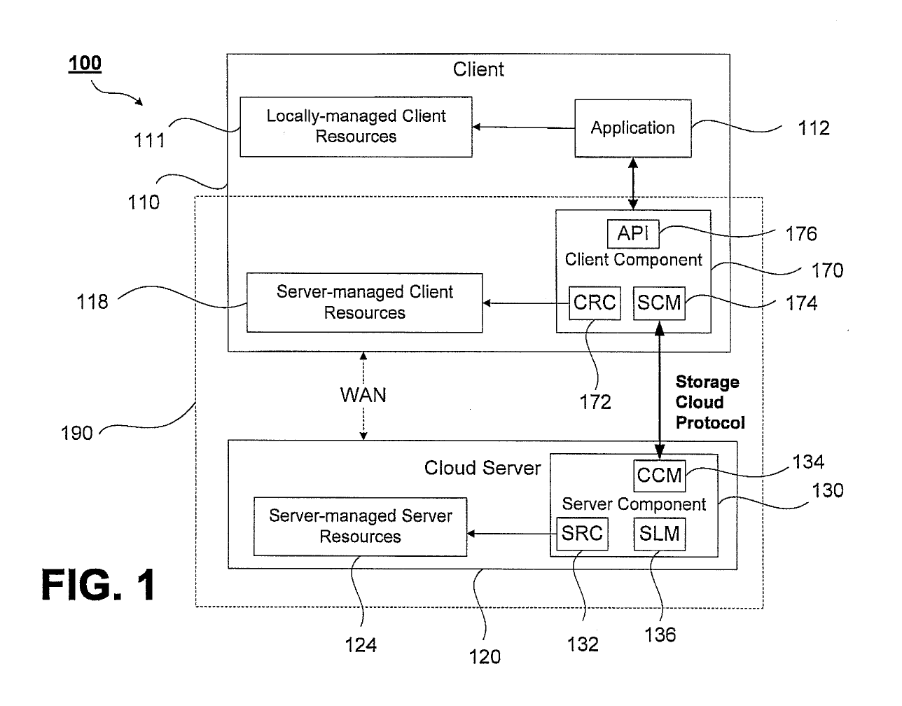

Referring now to the drawings in which like numerals represent the same or similar elements and initially to FIG. 1, a decentralized cloud storage architecture 100 is illustratively depicted in accordance with the present principles. As shown therein, a client 110 is coupled to a cloud server 120 via a network (e.g., WAN).

The client 110 includes locally-managed client resources 111, server-managed client resources 118, a running application 112, and a cloud-storage client component 170. The cloud-storage client component 170 includes three modules: a client-resource controller module (CRC) 172, a server communication module (SCM) 174 and an application program interface module (API) 176.

The cloud server 120 includes server resources 124 and cloud-storage server component 130. Cloud-storage server component 130 includes a server-resource controller module (SRC) 132, a client communication module (CCM) 134 and a server logic module (SLM) 136. A decentralized cloud 190 is shown which includes the resources of the cloud server 120 and a portion of the client's 110 resources.

Client 110 may comprise a computer, a cell phone, personal digital assistant, or any other device which is capable of communicating with cloud server 120 through a network. Cloud server 120 represents a server that is associated with a cloud storage service provider. The client 110 and the server 120 communicate with each other using a specialized storage cloud protocol via server communication module 174 and client communication module 134.

The resources at the client 110 may comprise a solid state memory (SSD), hard disk drive (HDD), random access memory (RAM), central processing unit (CPU), networking resources, etc. Additional storage, computing or other types of resources may be located at the client 110 as well. The client's resources may be divided into two categories: locally-managed client resources 111 and server-managed client resources 118.

The locally-managed resources 111 are under the control of the client 110. For example, these resources may be controlled by a client's operating system or applications running on the client 110. On the other hand, server-managed resources 118 represent a portion of resources on the client machine 110 which have been delegated, allocated or partitioned for use with the cloud storage service. For example, these resources 118 may be controlled by a server 120 located at or associated with a cloud storage provider. More specifically, the client communication module 134 may communicate with the server communication module 174 using a specialized storage cloud protocol to control the server-managed client resources 118 which have been delegated to the cloud storage service.

Like the client 110, server 120 may also include a variety of different resources such as solid state memory (SSD), hard disk drive (HDD), random access memory (RAM), central processing unit (CPU), networking resources, etc. These resources permit the client 110 to store data remotely at the server 120, and may serve to improve the overall performance of the cloud service.

Client-resource controller 172 and server-resource controller 132 manage the resources 118 and 124 of the decentralized cloud 190. For example, controllers 172 and 132 may be configured to implement a number of different functions including, but not limited to, reading/writing data, transmitting data over a network, caching data/metadata, performing “write-back” or “read-ahead” operations to reduce client-perceived access latency, encrypting or decrypting data, managing keys associated with encrypting and decrypting data, compressing or decompressing data or implementing de-duplication operations. The specific functions which are implemented may vary between different embodiments.

By allocating a portion of resources (e.g., local storage) at the client 110 to be managed by the cloud storage service, the server logic module 136 at the cloud server 120 can allocate or delegate functions to be implemented on the client 110, implemented by the server 120, or shared between the client 110 and the server 120. The determination as to whether functions are to be implemented by the client 110, the server 120, or both may be made in a variety of different ways. For example, the determination may be based on the hardware resources of the client 110 and the server 120, user-selected preferences, default system parameters, the current state of the client and/or server resources, or based upon a decision made at the cloud service provider.

For example, in cases where the server includes large volumes of low-cost disks and the client has a relatively small amount of persistent storage in the form of SSD, the server may take on a role for storing data while the SSD of the client may take on a role for improving performance (for example, by reducing the latency perceived by the user as described below).

In certain useful embodiments, the server logic module 136 may allocate storage (e.g., SDD) at the client to serve as a “read-cache” and/or a “write-behind cache” (also known as a write-back cache) to reduce the latency experienced by a user at the client (e.g., latency associated with I/O operations). In serving as a read-cache, the user can improve the latency associated with read requests by anticipating future read requests and caching data in advance.

On the other hand, by acting as a write-behind cache, the perceived latency associated with writing data to the server can be reduced because the user does not have to wait for the information, which is to be stored remotely, to actually be written to the remote server 120. Rather, such information can be stored temporally at the client 110 and transmitted to the cloud server 120 at a later time. One skilled in the art would recognize that temporarily storing data at the client presents the risk of data loss. Advantageously, the present principles allow the amount of risk to be configurable based on the preferences of the user.

For example, the client can specify an upper bound on the amount of time data is cached locally before being sent to the server; this limits the potential of data loss only to data recently written. Or, the client can select a “write-through” policy which requires data to be written to the server before being acknowledged; this improves reliability at the cost of the higher write latency. In addition, the client can employ one or more of known reliability schemes (e.g., RAID) to reduce the risk of data loss at the client.

In other embodiments of the present principles, the server logic module 136 may also allocate responsibility between the client 110 and the server 120 for functions relating to de-duplication, data compression, privacy (e.g., encryption and decryption of data), and storage. The manner in which the server logic module 136 assigns responsibilities for functions is described in greater detail below.

Application 112, which is running on client 110, utilizes the storage space on the cloud server 120 in some manner. For example, the application 112 may represent an application for backing up data, archiving data, computer-aided design (CAD), streaming media, or any other type of application which can be used in conjunction with a cloud storage service. Application 112 is able to communicate with the cloud-storage client component 170 via an application program interface (API) module 176 which allows for communication between the decentralized cloud 190 and the application 112 running on the client. For example, application 112 may communicate a request to write data to server 120 or may issue a request to read data stored from the server 120 via API module 176.

The API module may provide a data path and control path for the client to read and write data and control commands to and from the decentralized cloud storage. The API module may permit users to specify whether all data or a particular portion of data is to be encrypted before being transmitted to the remote server 120. In certain embodiments, the API module 176 may also gather or receive information from the application 112 and use this information to influence decisions made by the client component 170. For example, information gathered or received at the API module 176 may be used to affect decisions regarding whether data is to be stored locally or remotely. It may also affect decisions regarding caching, write-back delay, etc. In the absence of such information, the client component 170 may make decisions based on default settings (e.g., based upon the manner in which server logic module 136 has allocated responsibility for functions) or based upon access pattern analysis.

The type of information gathered by the API can be explicit (specified by a user) or implicit (inferred from analyzing the data). Furthermore, the information could be a treated as a command or as a “hint” or suggestion. For example, client may explicitly specify whether certain data is short-lived or long-lived; short-lived or temporary data need not be transmitted to the cloud storage server. Similar information can also be gathered through implicit information. For example, all files with extensions “.tmp” are to be treated as temporary files and are not to be transmitted immediately to the server.

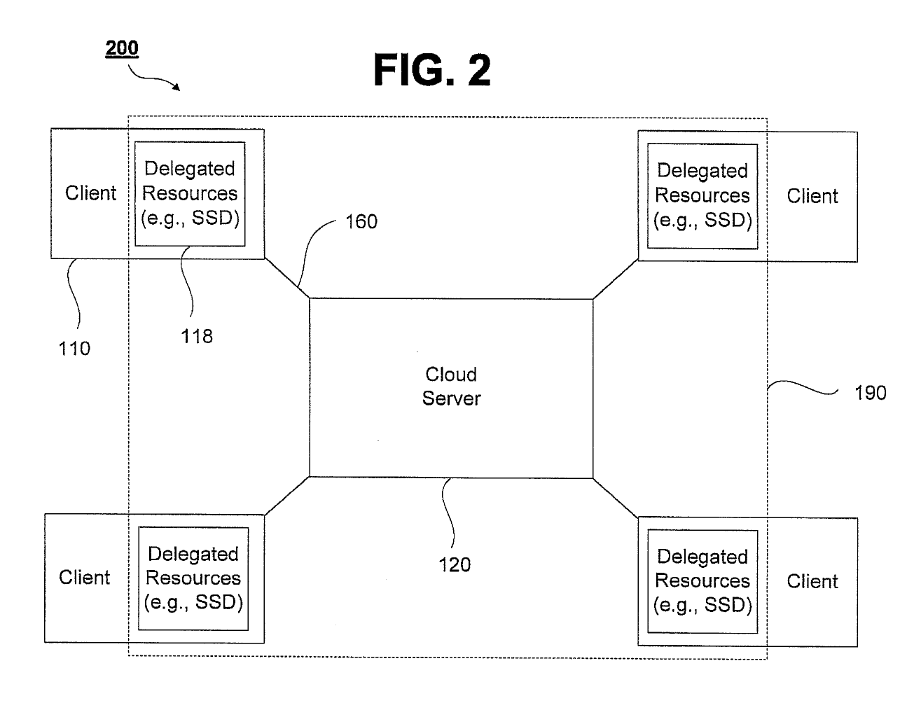

Referring to FIG. 2, a decentralized cloud storage architecture 200 is illustratively depicted which includes a plurality of clients 110 coupled to a decentralized cloud server 120. Each client 110 is coupled to a cloud server 120 through a link 160. The clients 110 delegate a fraction of their resources 118 to be used in conjunction with and managed by decentralized cloud service. The block labeled 190 represents the decentralized cloud comprising the resources of the cloud server 120 and the fraction of resources 118 delegated by the clients.

Each of the clients 110 may represent entirely separate machines which act independently and which use the cloud storage service for its own purposes. In this case, clients 110 do not share common data stored remotely on the server 120. Rather, each client 110 may have access to a separate portion of storage or other resources on the server 120.

Alternatively, each of the clients 110 may be working in collaboration toward a common goal and may have access to the same storage space on cloud server 120. This arrangement may be particularly advantageous with certain workloads. For example, this arrangement will be particularly useful for computer assisted design (CAD) projects, photo sharing software and office productively and collaboration software.

Consider the case where the cloud storage service is being utilized in conjunction with a CAD project which involves multiple developers. A CAD workload itself typically consists of sequential reads followed by updates to large design-data sets and is known to be I/O intensive. Each of the developers could access common data stored on the server 120 which pertains to the CAD project. Moreover, the decentralized cloud storage architecture would serve to optimize the latencies associated with such I/O intensive tasks.

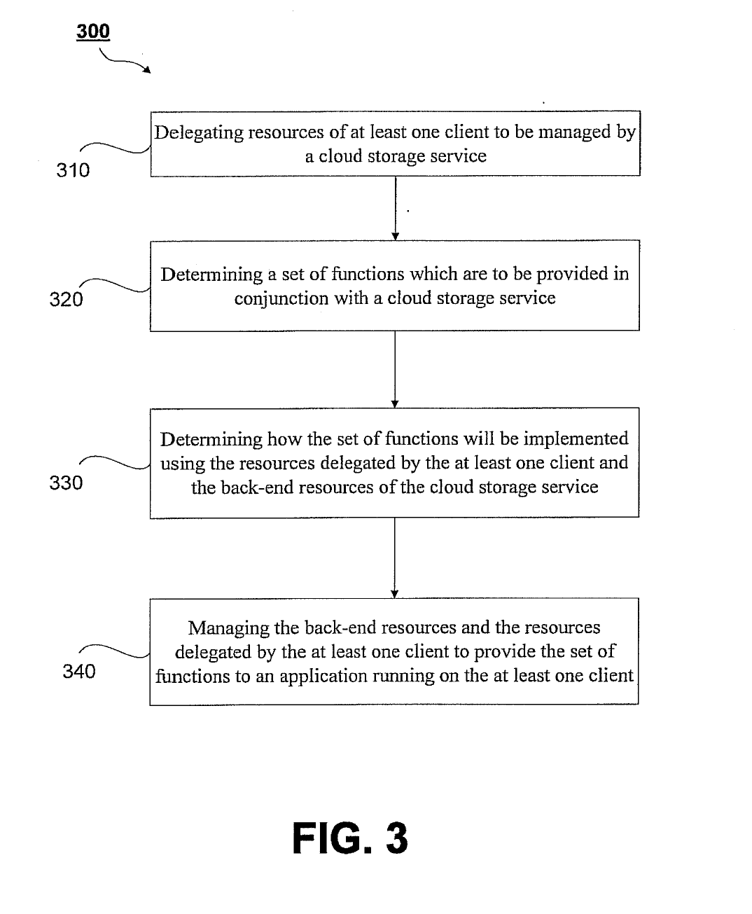

Referring to FIG. 3, a method for providing a decentralized cloud storage system 300 in accordance with one embodiment of the present principles is illustratively depicted. In block 310, at least one client 110 delegates resources 118 to be managed by a cloud storage service provider. This may involve allocating storage resources (e.g., SSD, HDD, RAM, etc.), processing resources, or other types of resources at the client 110 to be managed by a server 120 associated with the cloud storage service. The particular resources delegated to the cloud storage service may be based on user preferences, access patterns or hardware available at the client.

Next, in block 320, a determination is made regarding which functions are to be provided by the cloud storage service. For example, functions may be provided which relate to reading/writing data (both locally to resources 118 and remotely to resources 124), transmitting data over a network, caching data/metadata, performing write-back or read-ahead operations, encrypting or decrypting data, managing encryption/decryption keys, compressing/decompressing data and de-duplications operations.

The set of functions which are to be provided may depend upon the particular application 112 being executed on the client 110 or may depend upon a set of functions which have been selected by a user. For example, a user who is executing an application 112 which stores confidential data on the server 120 would likely want the data to be encrypted before sending the data over a network to be stored remotely. Thus, the application 112 could be configured to automatically communicate the request for encrypting data (or for any other function) to the client component 170 via API module 176, or the API module 176 may provide a user interface which would permit the user to select whether the data being transmitted is to be encrypted. Client component 170 may then communicate the encryption request to the cloud server component 130. Upon receiving the request, the server logic module 136 may then determine an appropriate manner of partitioning the client-delegated resources 118 and the server resources 124 to provide for the encryption of data and the maintenance of encryption keys (block 330).

The server logic module 136 can delegate functions to be implemented by the client 110, by the server 120, or to be shared between the client 110 and the server 120. In block 330, the manner in which the server logic module 136, or other means, determines how the set of functions will be delegated may be based on the resources or hardware available at the client 110 and the server 120. For example, some mechanism (e.g., server logic module 136) may analyze the hardware resources at both the server 120 and the client 110, as well as the access patterns of the user, and use this information to determine an appropriate manner of allocating functions between the client 110 and the cloud server 120. The allocation of resources may also be based (in whole or in part) upon user-selected preferences, default system parameters, the current state of the client and/or server resources, a decision made at the cloud service provider.

Deciding how to allocate resources may also involve making a determination as to how adaptive compression should be implemented, determining whether client 110 can allocate a portion of an SSD, HDD or RAM to be used for caching, or determining whether client 110 has available processing power that can be used to compress or encrypt data before transmitting data to the server 120.

Consider the case where compression is being implemented on a decentralized cloud storage system. As several data objects are being sent from the client 110 to the server 124, a subset of the data objects may be compressed at the client 110 and a subset may be compressed at the server 120. To determine what fraction of data should be compressed at the client 110 and the server 120, a threshold value may be determined which is based on the relative availability of client resources such as CPU. For example, when an object is received, compression may be performed at the client 110 if the CPU utilization of the client 110 is below a threshold. On the other hand, compression can be performed at the server 120 if the CPU utilization exceeds the threshold. This is referred to herein as “adaptive compression”.

In another embodiment, a user may select the manner in which functions are divided between the client 110 and the server 120. API module 176, or some other mechanism, may provide the user with an interface which permits the user to determine the manner in which functions are allocated. For example, the user could utilize the interface to select whether the data being stored on server 120 would be compressed on the client-end or on the server-end, or whether data de-duplication operations should be implemented on the client-end, on the server-end or both.

In an even further embodiment, both the available hardware resources and user input are used to divide functions between the client 110 and the server 120. For example, the hardware resources of the client 110 and the server 120 may be analyzed and the server logic module 136 may determine default preferences for allocating resources. The default preferences would be implemented so long as the user has not provided input which is contrary to the default settings. However, if the user has provided input which is contrary to the default settings, the system may provide some prioritization/conflict resolution based on the semantics of the API 176.

Table 1 below shows one particularly useful manner of partitioning functionality between the clients 110 and the server 120 in a decentralized cloud service.

TABLE 1

| Functionality | Client | Server |
|---|---|---|
| Capacity | No | Yes |
| Resiliency | No | Yes |
| De-duplication | Yes | Yes |
| Sharing | No | Yes |
| Performance | Yes | No |
| Privacy | Yes | No |
| Compression | Yes | Yes |

Given that most servers are outfitted with large amounts of storage space and with the ability to efficiently communicate with numerous clients all at once, the server is allocated functions which relate to storage capacity, resiliency against failures and sharing of data amongst multiple clients. On the other hand, the clients have been delegated functions related to improving the performance and ensuring privacy. Clients can improve performance by dedicating a local SSD or other storage device to reduce latency delays (e.g., using an SSD or other device as a write-buffer or a read-cache). Moreover, since many users do not wish to trust third parties with the security of data, the client has also been assigned the task of encrypting data and maintaining the encryption keys locally to ensure that the data being transmitted over the network is kept confidential.

In Table 1, the function of de-duplication has been assigned to both the client 110 and the server 120. Implementing a de-duplication function relates to eliminating or reducing duplicate data to avoid wasting resources unnecessarily. The client 110 may perform de-duplication operations to reduce or eliminate duplication of data being transmitted over the network, while the server 120 may perform de-duplication operations to reduce or eliminate duplication of data which is stored at server 120.

Regardless of how the functions are divided between the client 110 and the server 120, in block 340, the back-end resources 124 of the cloud storage service and the resources 118 delegated by the client 110 are managed accordingly to provide the set of functions to an application 112 running on the client 110.

One of ordinary skill in the art would recognize that the decentralized cloud storage architecture described herein provides for a number of advantages over conventional cloud storage systems including:

(1) Reduced Cost: By delegating functions to be performed by the client, the server can be run at a lower operating point while still sustaining the same overall performance and scalability requirements. This makes the entire setup more cost-effective. A service provider can invest in cheaper server hardware such as lower RPM disks, power-efficient disks and processors, and little or no SSDs, with the expectation that clients will be able to delegate SSDs to improve performance of applications. Additional resource savings are possible through use of the custom protocol (e.g., used for communication between the server communication module 174 and the client communication module 134). For example, the custom protocol can increase the effectiveness of client-delegated storage through exclusive caching, more efficient duplicate elimination, more intelligent pre-warming, etc.

(2) Reduced Server Complexity: In decentralized cloud storage, a fraction of the requests will be absorbed locally at the client (e.g., temporary files may not be transferred to the server). Since some performance-critical operations get ameliorated due to client participation, the server architecture can itself be simplified and designed more for efficiency and less for peak performance. In addition, workloads at the server become more predictable, making it easier to provision the system for new clients.

(3) Reduced Application Complexity: Responsibility for making the best use of locally available resources is shifted from the application to the decentralized cloud. A suitable enriched cloud-storage API provides unified access to the local and remote storage pool that can make applications easier to create, and more amenable to handling changes in local and remote storage requirements.

(4) Reduced Latency: The present principles permit certain operations to be performed by the client without requiring the participation of the server. For example, the client-side storage can serve as a write-behind cache to reduce latency for asynchronous writes. Although synchronous writes to the server are not going to benefit from the reduced latency, improved client-side reliability mechanisms in the future can reduce the number of such requests. In addition, the read performance is improved not only because of the large capacity of local storage, but because the server may push data on to the client, based on prior access patterns or client-specified policies. Similarly, the server can also proactively push contents of modified files to collaborating clients in a shared environment. All of these measures serve to reduce latency at the client.

(5) Increased usage of cloud-storage by new applications: As a by-product of the above mentioned benefits (particularly, reduced latency and cost), applications that were previously not using a cloud-storage service can now consider it as a viable alternative. Decentralized cloud storage will provide a uniform solution across applications.

Having described preferred embodiments of a system and method for providing decentralized cloud storage (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system, comprising:
at least one client having local resources, said local resources comprising a first portion which is accessible to the at least one client and a second portion designated to be accessible to and managed by a cloud storage service having a computer readable storage medium;
a server logic module configured to allocate responsibility for performing a set of functions between back-end resources of a cloud storage service and the local resources designated by the at least one client; and
a controller configured to manage the resources designated by the at least one client to implement the functions which have been allocated to the at least one client.

2. The system of claim 1, wherein the local resources designated by the at least one client includes at least a portion of local storage which has been allocated responsibility for performing write-back operations and read-ahead operations to reduce latency at the at least one client.

3. The system of claim 1, further comprising an application program interface which provides a data path and control path for the at least one client to read and write data or control commands to and from the decentralized cloud storage.

4. The system of claim 3, wherein the application program interface is configured to gather or receive information from an application being executed on the at least one client and use this information to influence decisions regarding how to utilize the back-end resources of the cloud storage service and the local resources designated by the at least one client.

5. The system of claim 1, further comprising an administrative user interface which permits a user to specify the manner in which the local resources are to be delegated and how the responsibility for performing the set of functions is to be allocated between back-end resources of a cloud storage service and the local resources that have been designated by the at least one client.

6. The system of claim 1, wherein the local resources designated by the at least one client are used to encrypt data before transmission and to maintain at least one key used for encrypting the data.

7. The system of claim 1, wherein the responsibility for performing de-duplication is shared between the designated resources of the at least one client and the back-end resources.

8. The system of claim 1, wherein the at least one client comprises a plurality of clients working in collaboration and each client has access to common resources, said common resources being comprised of resources designated by each of the plurality of clients and resources provided by a remote server associated with the cloud storage service.

9. The system of claim 1, wherein the controller is installed at the at least one client and makes decisions regarding resource management using both information received from the back-end of the cloud storage service and information received from an application program interface which gathers information about an application being executed on the at least one client.

10. A method, comprising:
designating local resources of at least one client to be managed by a cloud storage service which comprises a computer readable storage medium;
determining a set of functions which are to be provided to an application on the at least one client in conjunction with a cloud storage service;
allocating responsibility for performing the set of functions between back-end resources of the cloud storage service and the local resources designated by the at least one client; and
managing the local resources designated by the at least one client to implement the functions which have been allocated to the at least one client.

11. The method of claim 10, wherein the local resources designated by the at least one client include at least a portion of local storage which has been allocated responsibility for performing delayed write-back operations and read-ahead operations to reduce latency at the at least one client.

12. The method of claim 10, wherein an application program interface provides a data path and control path for the at least one client to read and write data or control commands to and from a decentralized cloud storage.

13. The method of claim 12, wherein the application program interface is configured to gather or receive information from an application being executed on the at least one client and use this information to influence decisions regarding how to utilize the back-end resources of the cloud storage service and the local resources designated by the at least one client.

14. The method of claim 10, wherein an administrative user interface permits a user to specify the manner in which the local resources are to be delegated and how the responsibility for performing the set of functions is to be allocated between back-end resources of a cloud storage service and the local resources that have been designated by the at least one client.

15. The method of claim 10, wherein the local resources designated by the at least one client are used to encrypt data before transmission and to maintain at least one key used for encrypting the data.

16. The method of claim 10, wherein the responsibility for performing de-duplication is shared between the designated resources of the at least one client and the back-end resources.

17. The method of claim 10, wherein the at least one client comprises a plurality of clients working in collaboration and each client has access to common resources, said common resources being comprised of resources designated by each of the plurality of clients and resources provided by a remote server associated with the cloud storage service.

18. The method of claim 10, wherein the cloud storage service includes a controller which is installed at the at least one client and which makes decisions regarding resource management using both information received from the back-end of the cloud storage service and information received from an application program interface that gathers information about an application being executed on the at least one client.
